(19) United States
(12) Patent Application Publication
(10) Pub. No.: US 2023/0286562 A1
(43) Pub. Date: Sep. 14, 2023

(54) Elevated Step Assist Apparatuses

(71) Applicant: Cody Lewis, Stonewall, LA (US)

(72) Inventor: Cody Lewis, Stonewall, LA (US)

(21) Appl. No.: 17/583,762

(22) Filed: Jan. 25, 2022

(51) Int. Cl. B62B 3/02; E06C 5/00; B62B 5/06; A47C 12/00

(52) U.S. Cl. CPC B62B 3/02; A47C 12/00; B62B 5/06; E06C 5/00; B62B 2206/006

(57) ABSTRACT

An elevated step assist apparatus configured to support a load on a surface may include a transport assembly. The transport assembly may include a plurality of transport wheels configured to rest on the surface. A transport platform may be supported by the transport wheels. A load support assembly may be disposed over the transport assembly. The load support assembly may be deployable in an elevated, transport position in which the load support assembly is configured to be elevated with respect to the surface and a depressed, stationary load bearing position in which the load support assembly is configured to rest on the surface. The load support assembly may include a support assembly platform configured to receive the load. A plurality of support assembly legs may extend from the support assembly platform. A plurality of platform biasing devices may bias the load support assembly in the elevated, transport position.

### FIELD

Illustrative embodiments of the disclosure generally relate to apparatuses for enabling a user to reach elevated areas on walls, ceilings, shelves, and other structures. More particularly, illustrative embodiments of the disclosure relate to elevated step assist apparatuses which can be used to transport one or more items across a surface or to support and enable a user to walk across a surface while elevating the user so that the user can reach elevated areas.

### SUMMARY

Illustrative embodiments of the disclosure are generally directed to an elevated step assist apparatus configured to support a load on a surface. An illustrative embodiment of the elevated step assist apparatus may include a transport assembly. The transport assembly may include a plurality of transport wheels configured to rest on the surface. A transport platform may be supported by the transport wheels. A load support assembly may be disposed over the transport assembly. The load support assembly may be deployable in an elevated, transport position in which the load support assembly is configured to be elevated with respect to the surface and a depressed, stationary load bearing position in which the load support assembly is configured to rest on the surface. The load support assembly may include a support assembly platform configured to receive the load. A plurality of support assembly legs may extend from the support assembly platform. A plurality of platform biasing devices may bias the load support assembly in the elevated, transport position.

### BRIEF DESCRIPTION OF THE DRAWINGS

Illustrative embodiments of the disclosure will now be described, by way of example, with reference to the accompanying drawings, in which:

FIG. 1 is a front perspective view of an illustrative embodiment of the elevated step assist apparatuses, with a typical handle deployed in place on the apparatus:

FIG. 2 is a front perspective view of the illustrative elevated step assist apparatus illustrated in FIG. 1, with the handle removed from the apparatus;

FIG. 3 is a perspective view of the illustrative elevated step assist apparatus, with a vacuum cleaner supported on the apparatus for transport of the vacuum cleaner across a surface in typical application of the apparatus;

FIG. 4 is a front perspective view of a pair of adjacent, left and right elevated step assist apparatuses with the left and right feet of a user standing on the respective left and right apparatuses as the user walks across a surface on the apparatuses in typical application of the apparatuses, with the right apparatus supporting the right foot of the user in an elevated, transport position and the left apparatus supporting the left foot of the user in a depressed, stationary load bearing position:

FIG. 5 is an enlarged sectioned perspective view of the illustrative elevated step assist apparatus, more particularly illustrating a typical platform lock assembly deployed in an unlocking position to facilitate selective deployment of the load support assembly between the transport position and the stationary load bearing position;

FIG. 6 is an enlarged sectioned perspective view of the illustrative elevated step assist apparatus illustrated in FIG. 5. with the platform lock assembly deployed in a locking position to facilitate selective deployment and locking of the apparatus in the transport position;

FIG. 7 is a side view of the illustrative elevated step assist apparatus, with the load support assembly of the apparatus deployed in the transport position in typical application of the apparatus;

FIG. 8 is a side view of the illustrative elevated step assist apparatus, with the load support assembly of the apparatus deployed in the stationary load bearing position in typical application of the apparatus; and

FIG. 9 is a sectional view, taken along section lines 9-9 in FIG. 1.

### DETAILED DESCRIPTION

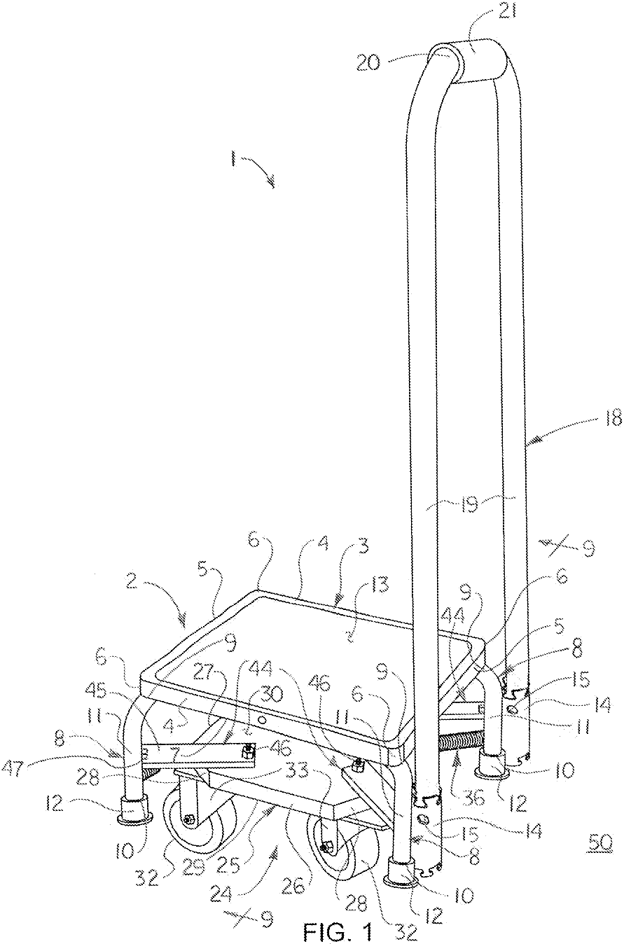

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”. “lower”. “left”, “rear”, “right”. “front”, “vertical”, “liorizoiital”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

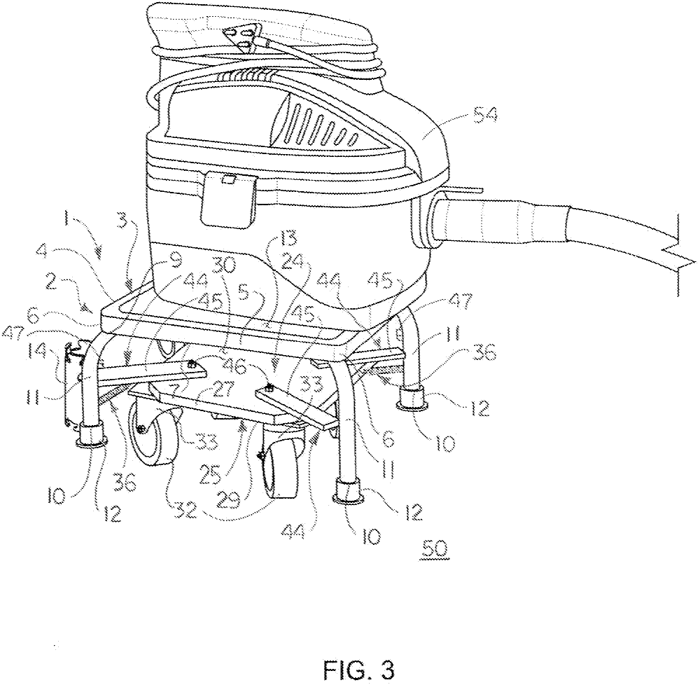

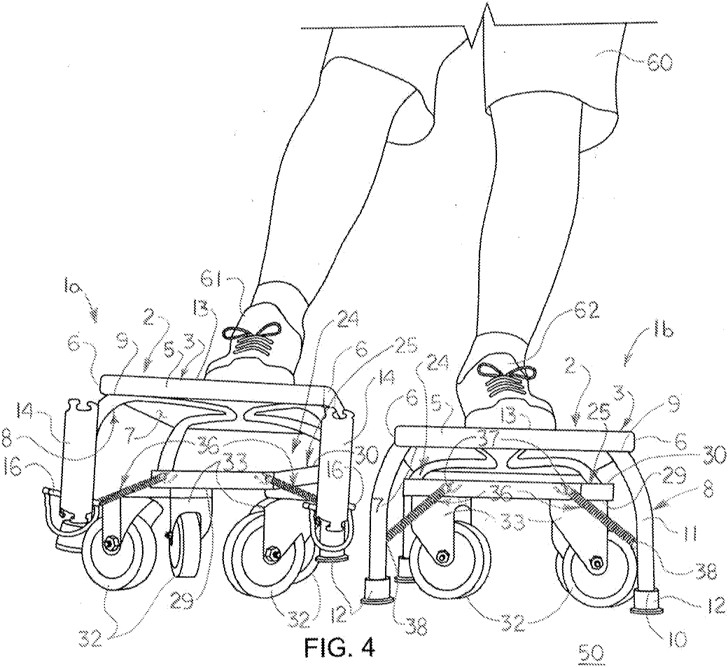

Referring to the drawings, an illustrative embodiment of the elevated step assist apparatuses, hereinafter apparatus, is generally indicated by reference numeral 1. In typical application, which will be hereinafter described, the apparatus 1 may be used to transport one or more items across a surface 50 or to support and enable a user to walk across a surface 50 while elevating the user so that the user can reach elevated areas on walls, ceilings, shelves, and other structures. For example and without limitation, as illustrated in FIG. 3. in some applications, the apparatus 1 may be placed on a floor or other surface 50 to transport one or more items such as a vacuum cleaner 54, for example and without limitation, across the surface 50. As illustrated in FIG. 4. in other applications, a pair of apparatuses 1. illustrated as a right apparatus 1a and a left apparatus 1b, may be placed adjacent to each other on the surface 50. The right apparatus 1a and the left apparatus 1b may support the respective right foot 61 and left foot 62 of a user 60 and enable the user 60 to walk across the surface 50. as the user 60 alternately and repeatedly stands on the right apparatus 1a and the left apparatus 1b, while elevating the user 60 so that the user 60 can reach the elevated area or areas. In still other applications, the apparatus 1 may securely and immovably support the user 60 on the surface 50 as the user 60 stands or sits on the apparatus 1. typically as will be hereinafter described.

The apparatus 1 may include a transport assembly 24. The transport assembly 24 may be configured to render the apparatus 1 portable on the surface 50. In some embodiments, the transport assembly 24 may include a plurality of transport wheels 32. The transport wheels 32 may be configured to rest on and traverse the surface 50. In some embodiments, each of the transport wheels 32 may have a polyurethane coating (not illustrated).

A transport platform 25 may be supported by the transport wheels 32. The transport platform 25 of the transport assembly 24 may have any suitable size and shape. For example and without limitation, in some embodiments, the transport platform 25 may be generally elongated and rectangular with a pair of elongated, parallel, spaced-apart longitudinal transport platform edges 26 and a pair of elongated, parallel, spaced-apart transverse transport platform edges 27 extending between the longitudinal transport platform edges 26. A plurality of transport platform corners 28 may be disposed between the respective longitudinal transport platform edges 26 and transverse transport platform edges 27. In some embodiments, the transport platform corners 28 may be truncated, as illustrated. A lower transport platform surface 29 and an upper transport platform surface 30 may be bounded by the longitudinal transport platform edges 26, the transverse transport platform edges 27 and the transport platform corners 28.

A wheel frame 33 may attach each transport wheel 32 to the transport platform 25. in some embodiments, each transport wheel 32 may include a castor wheel which is rotatably or swivally mounted to the wheel frame 33 as is known by those skilled in the art. Accordingly, the castor wheels 32 may impart multi-directional transport movability to the apparatus 1 on the surface 50. The wheel frame 33 of each transport wheel 32 may be attached to the lower transport platform surface 29 of the transport platform 25 according to the knowledge of those skilled in the art.

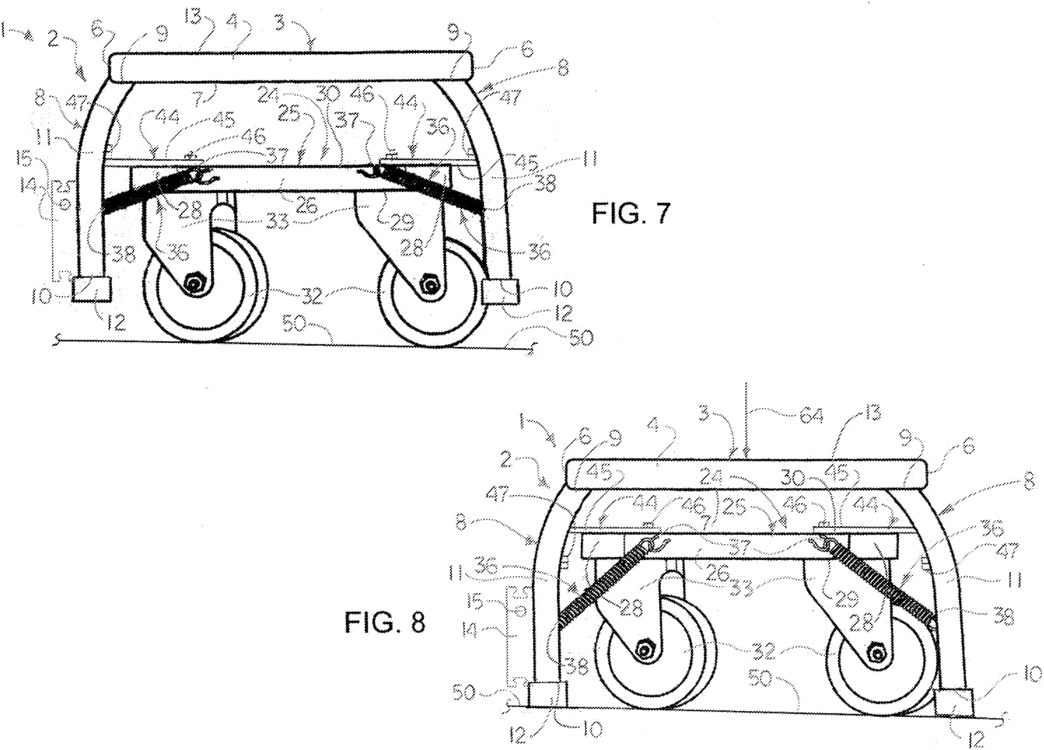

A load support assembly 2 may be disposed over the transport assembly 24. The load support assembly 2 may be deployable in an elevated, transport position (FIG. 7) in which the load support assembly 2 is configured to be elevated with respect to the surface 50 for transport of the apparatus I on the surface 50 via the transport assembly 24. The load support assembly 2 may be deployable in a depressed, stationary load bearing position (FIG. 8) in which the load support assembly 2 is configured to rest on the surface 50 and mobilize the apparatus 1 on the surface 50, typically responsive to placement of a load 64 thereon.

The load support assembly 2 may have any design or construction which renders the load support assembly 2 capable of receiving and supporting the load 64 (FIG. 8). In some embodiments, the load support assembly 2 may include a support assembly platform 3 configured to receive and support the load 64. A plurality of support assembly legs 8 may extend from the support assembly platform 3. A plurality of platform biasing devices 36 may connect the respective support assembly legs 8 of the load support assembly 2 to the transport platform 25 of the transport assembly 24. The platform biasing devices 36 may be configured to bias the load support assembly 2 in the elevated. transport position illustrated in FIG. 7. In some embodiments, the platform biasing devices 36 may be configured to contract and relax to suspend the load support assembly 2 from the transport assembly 24 in the elevated, transport position of the load support assembly 2. The platform biasing devices 36 may be configured to extend and tension between the transport assembly 24 and the load support assembly 2 in the depressed, stationary load bearing position (FIG. 8) of the load support assembly 2.

Each platform biasing device 36 may include any type of device or combination of devices capable of biasing the load support assembly 2 in the elevated, transport position (FIG. 7) and resisting deployment of the load support assembly 2 from the transport position to the depressed, stationary load bearing position (FIG. 8). For example and without limitation, in some embodiments, each platform biasing device 36 may include at least one coiled platform suspension spring. Accordingly, the platform suspension spring or springs of each platform biasing device 36 may be configured to contract and suspend the load support assembly 2 from the transport assembly 24 in the elevated, transport position of the load support assembly 2. Conversely, the platform suspension spring or springs of each platform biasing device 36 may be configured to tension between the transport assembly 24 and the load support assembly 2 in the depressed, stationary load bearing position of the load support assembly 2. In some embodiments, each platform biasing device 36 may include at least one pneumatic or hydraulic cylinder.

As particularly illustrated in FIGS. 7 and 8, each platform biasing device 36 may have a platform attachment end 37 attached to the transport platform 25 of the transport assembly 24 and a leg attachment end 38 attached to a corresponding one of the support assembly legs 8 of the load support assembly 2. In some embodiments, the platform attachment end 37 of each platform biasing device 36 may be attached to a longitudinal transport platform edge 26 of the transport platform 25. The leg attachment end 38 of each platform biasing device 36 may be attached to the support assembly leg 8. Accordingly, the platform biasing devices 36 may be configured to contract and lift the load support assembly 2 from the surface 50 and suspend the load support assembly 2 from the transport assembly 24 in the elevated, transport position (FIG. 7) of the load support assembly 2. The platform biasing devices 36 may be configured to stretch and tension between the transport platform 25 of the transport assembly 24 and the respective support assembly legs 8 of the load support assembly 2 as the load 64 is placed on the support assembly platform 3 and as the load support assembly 2 consequently deploys from the elevated, transport position to the depressed, stationary load bearing position (FIG. 8), typically until the support assembly legs 8 rest on the surface 50.

The support assembly platform 3 of the load support assembly 2 may have any suitable size and shape which is consistent with the purpose of supporting the load 64. For example and without limitation, in some embodiments, the support assembly platform 3 may be generally elongated and rectangular with a pair of elongated, parallel, spaced-apart longitudinal load support platform edges 4 and a pair of elongated, parallel, spaced-apart transverse load support platform edges 5 extending between the longitudinal load support platform edges 4. A plurality of load support platform corners 6 may be disposed between the longitudinal load support platform edges 4 and the adjacent transverse load support platform edges 5. A lower load support platform surface 7 and an upper load support platform surface 13 may be bounded by the longitudinal load support platform edges 4. the transverse load support platform edges 5 and the load support platform corners 6. In some embodiments, the upper load support platform surface 13 of the support assembly platform 3 may be provided with a non-slip texture according to the knowledge of those skilled in the art.

In some embodiments, each support assembly leg 8 may have a proximal leg end 9 at the lower load support platform surface 7 of the support assembly platform 3: a distal leg end 10 opposite the proximal leg end 9; and a leg midpoint 11 midway between the proximal leg end 9 and the distal leg end 10. The leg attachment end 38 of each platform biasing device 36 may be attached to each corresponding support assembly leg 8 between the distal leg end 10 and the leg midpoint 11 thereof. The length of each platform biasing device 36 may be selected such that the load support platform corners 6 on the support assembly platform 3 of the load support assembly 2 are equally suspended with respect to the respective transport platform corners 28 on the transport platform 25 of the transport assembly 24. A typically rubber or plastic foot 12 may be fitted on the distal leg end 10 of each support assembly leg 8. The feet 12 on the respective support assembly legs 8 may be configured to rest flat on the surface 50 to support the load support assembly 2 and the load 64 thereon on the surface 50 in the stationary load bearing position of the load support assembly 2 (FIG. 8).

As illustrated in FIG. 1. in some embodiments, at least one handle 18 may be provided on the load support assembly 2 of the apparatus 1. The handle 18 may be supported by the support assembly legs 8 of the load support assembly 2, as illustrated. Additionally or alternatively, the handle 18 may be supported by the support assembly platform 3 of the load support assembly 2 and/or to one or more elements of the transport assembly 24. The handle 18 may enable the user 60 to push or pull the apparatus 1 along the surface 50 typically as the user stands or walks on the surface 50 and grips and pushes or pulls the handle 18.

In some embodiments, the handle 18 may be selectively removable with respect to the load support assembly 2 according to the knowledge of those skilled in the art. Accordingly, at least one handle sleeve 14 may be supported typically by one or more of the support assembly legs 8. The handle 18 may be removably insertable and retainable in the handle sleeve or sleeves 14 typically as will be hereinafter described. The handle sleeve or sleeves 14 may be attached to the respective support assembly leg or legs 8 using mechanical fasteners, welding and/or other suitable attachment technique known by those skilled in the art.

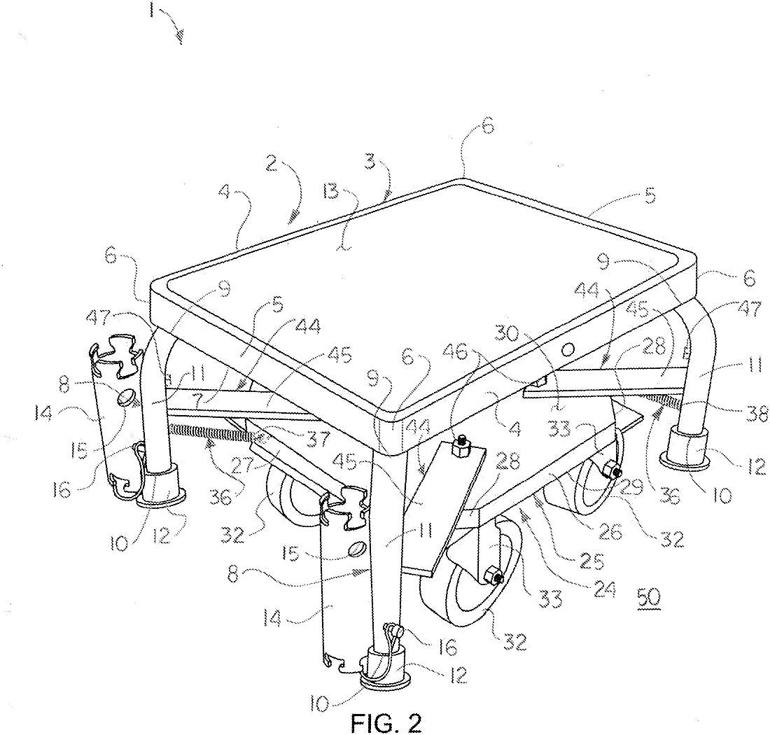

As illustrated in FIGS. 1 and 2, in some embodiments, a pair of the handle sleeves 14 may be provided on a respective pair of the support assembly legs 8 of the load support assembly 2. As illustrated in FIG. 1, the in some embodiments, the handle 18 may include a pair of elongated, parallel, spaced-apart vertical handle members 19. A horizontal handle member 20 may extend between the vertical handle members 19. A handle grip 21 may be provided on the horizontal handle member 20. The lower ends of the vertical handle members 19 may be removably insertable in the respective handle sleeves 14. In other embodiments, the handle 18 may include a T-handle or may have any alternative design which mounts to the load support assembly 2 and/or to the transport assembly 24 via the handle sleeve or sleeves 14 and/or other mounting structure or technique which is suitable for the purpose.

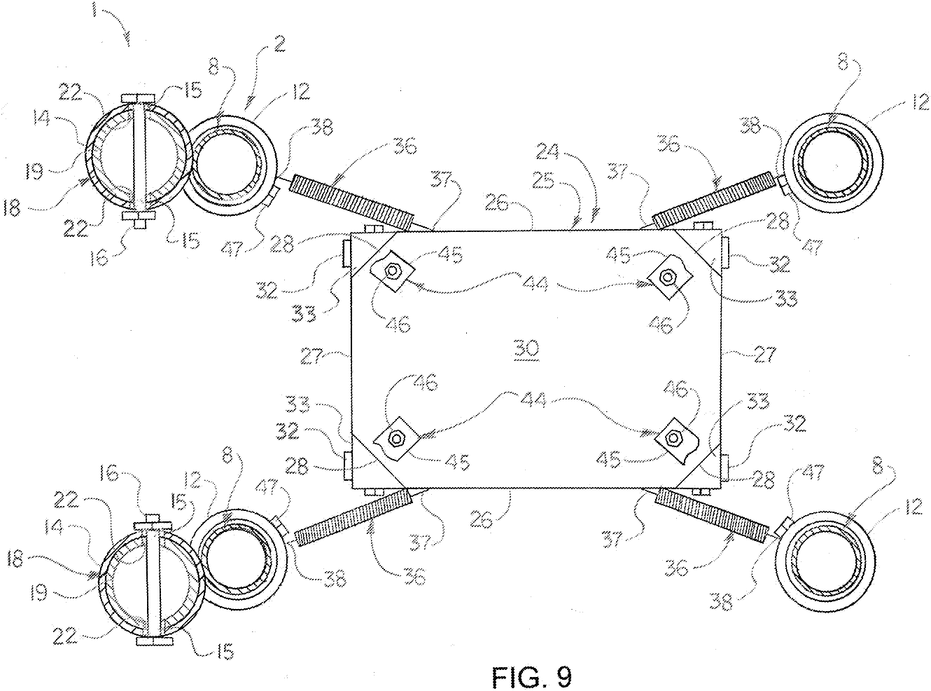

The vertical handle members 19 of the handle 18 may be retained in the respective handle sleeves 14 according to the knowledge of those skilled in the art. Accordingly, as illustrated in FIGS. 1, 2 and 9, in some embodiments, a pair of aligned sleeve pin openings 15 may be provided in each handle sleeve 14. As illustrated in FIG. 9, a pair of aligned handle member pin openings 22 may be provided in each vertical handle member 19 of the handle 18. Upon insertion of the vertical handle members 19 into the respective handle sleeves 14, the handle member pin opening 22 in each vertical handle member 19 may be disposed in registering relationship to the sleeve pin opening 15 in each corresponding handle sleeve 14. A retaining pin 16 may be extended through the sleeve pin opening 15 in each handle sleeve 14 and through the registering handle member pin opening 22 in the vertical handle member 19 to removably retain the vertical handle members 19 in the respective handle sleeves 14.

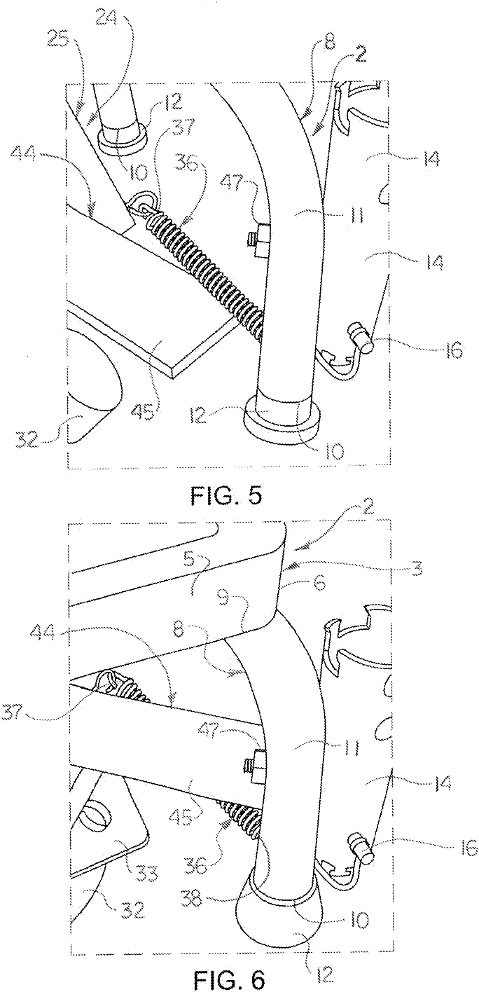

In some embodiments, at least one platform lock assembly 44 may be selectively deployable and configurable to maintain the load support assembly 2 in the elevated, transport position illustrated in FIG. 7. In some embodiments, a plurality of platform lock assemblies 44 may be provided for the purpose. Each platform lock assembly 44 may include an elongated lock member 45. The lock member 45 may be pivotally attached to the upper transport platform surface 30 of the transport platform 25 of the transport assembly 24, such as via a lock member fastener 46. Accordingly, as illustrated in FIG. 5, the lock member 45 may be selectively deployable in an unlocking position in which the lock member 45 disengages a corresponding one of the support assembly legs 8 to facilitate deployment of the load support assembly 2 between the transport position and the stationary load bearing position. As illustrated in FIG. 6, the lock member 45 may be selectively deployable in a locking position in which the lock member 45 engages the corresponding support assembly leg 8 to support and lock or maintain the load support assembly 2 in the transport position, typically for purposes which will be hereinafter described.

In some embodiments, each platform lock assembly 44 may include a lock member engaging element 47 on a corresponding one of the support assembly legs 8. Accordingly, in the locking position, the lock member engaging element 47 may be configured to engage the lock member 45 such that the lock member 45 retains or supports the load support assembly 2 in the transport position. For example and without limitation, as illustrated in FIGS. 6 and 7, the lock member 45 may be configured to pivot beneath and in the downward travel path of the lock member engaging element 47 as the load support assembly 2 deploys from the transport position to the stationary load bearing position. The lock member engaging element 47 may thus rest upon and thus prevent further depression of the load support assembly 2 with respect to the transport assembly 24. The lock member 45 may be configured to pivot from beneath and out of the downward travel path of the lock member engaging element 47 such that the load support assembly 2 is able to deploy from the transport position of FIG. 7 to the stationary load bearing position of FIG. 8.

The lock member engaging element 47 of the platform lock assembly 44 may include any component or combination of components which is engageable by the lock member 45 to block passage of the lock member engaging element 47 in the downward travel path direction such as to prevent deployment of the load support assembly 2 from the transport position to the stationary load bearing position. For example and without limitation, in some embodiments, the lock member engaging element 47 may include a bolt on the support assembly leg 8 and a nut threaded on the bolt.

As illustrated in FIG. 3, in some applications, the apparatus 1 may be placed on a floor or other surface 50 to facilitate transport of one or more items such as a vacuum cleaner 54, for example and without limitation, across the surface 50 from one location to another. Accordingly, the lock member 45 of one or more of the platform lock assemblies 44 may initially be deployed in the locking position illustrated in FIGS. 6 and 7 to lock and support or secure the load support assembly 2 in the elevated, transport position illustrated in FIG. 7. The thusly deployed lock member 45. positioned in the downward travel path of the lock member engaging element 47. may block the lock member engaging element 47 to prevent the load support assembly 2 from deploying to the depressed, stationary load bearing position illustrated in FIG. 8. Accordingly, the transport wheels 32 of the transport assembly 24 may support the apparatus 1 on the surface 50 to facilitate rolling transport of the apparatus 1 across the surface 50. The vacuum cleaner 54 may be placed on the support assembly platform 3 of the load support assembly 2 and the transport assembly 24 rolled on the surface 50 via the transport wheels 32 to transport the vacuum cleaner 54 to a desired location or destination for use. In some applications, the handle 18 (FIG. 1) may be deployed in the handle sleeves 14 typically as was heretofore described to enable the user to push or pull the apparatus 1 on the surface 50. At the desired location or destination, the vacuum cleaner 54 may be removed from the support assembly platform 3 for use or may alternatively remain on the support assembly platform 3 during use.

As illustrated in FIG. 4. in some applications, a pair of the apparatuses 1, shown as a right apparatus 1a and a left apparatus 1b, may be placed adjacent to each other on the surface 50. The platform lock assembly or assemblies 44 of each apparatus 1a, 1b may be deployed in the unlocking position to facilitate deployment of each corresponding load support assembly 2 between the transport position and the stationary load bearing position. A user 60 may place the respective right foot 61 and left foot 62 on and stand on the support assembly platforms 3 of the respective load support assemblies 2 on the right apparatus 1a and left apparatus 1b. As the apparatuses 1a, 1b elevate the user 60, the user 60 may walk by repeatedly and alternately lifting the right foot 61 on the right apparatus 1a and resting on the left foot 62 on the left apparatus 1b, as illustrated, and vice-versa.

As the user 60 walks on the right apparatus 1a and the left apparatus 1b, the right foot 61 of the user 60 is raised on the support assembly platform 3 of the load support assembly 2 on the right apparatus 1a. Accordingly, the platform biasing devices 36 may contract and raise or lift the load support assembly 2 of the right apparatus 1a from the surface 50 such that the transport wheels 32 of the transport assembly 24 support the right apparatus 1a on the surface 50. As the right foot 61 typically remains in contact with the support assembly platform 3, the user 60 may then move the right foot 61 forwardly or rearwardly to roll and transport the right apparatus 1a forwardly or rearwardly, respectively, on the surface 50 via the transport wheels 32 of the transport assembly 24. Simultaneously, the weight of the user 60 may remain supported by the left apparatus 1b through the user’s left foot 62. The load 64 (FIG. 8) which is applied by the weight of the user 60 through the left foot 62 thus maintains the load support assembly 2 of the left apparatus 1b in the stationary load bearing position, in which the feet 12 on the support assembly legs 8 of the load support assembly 2 on the left apparatus 1b rest upon the surface 50. The user 60 may subsequently shift weight from the left foot 62 to the right foot 61 such that the load support assembly 2 of the right apparatus 1a deploys from the stationary load bearing position to the transport position and the load support assembly 2 of the left apparatus 1b simultaneously deploys from the stationary load bearing position to the transport position. The user 60 may then shift the left foot 62 forwardly or rearwardly to roll the left apparatus 1b forwardly or rearwardly, respectively, on the surface 50 via the transport wheels 32 of the transport assembly 24. In the foregoing manner, the user 60 can “walk” across the surface 50 while reaching elevated areas on walls, shelves and other structures for the purpose of painting, repair, accessing items from elevated shelves and the like.

In some applications, the apparatus 1 may securely and immovably support the user 60 on the surface 50 as the user 60 stands or sits on the apparatus 1. Accordingly, the platform lock assembly or assemblies 44 may be deployed in the unlocking position to enable the load support assembly 2 to deploy from the transport position to the stationary load bearing position. The load 64 which is placed on the support assembly platform 3 of the load support assembly 2 may thus be supported on the surface 50 via the feet 12 on the support assembly legs 8 of the load support assembly 2.

While certain illustrative embodiments of the disclosure have been described above, it will be recognized and understood that various modifications can be made to the embodiments and the appended claims are intended to cover all such modifications which may fall within the spirit and scope of the disclosure.

What is claimed is:

1. An elevated step assist apparatus configured to support a load on a surface, comprising:
a transport assembly comprising:
a plurality of transport wheels configured to rest on the surface; and
a transport platform carried by the plurality of transport wheels:
a load support assembly disposed over the transport assembly and deployable in an elevated, transport position wherein the load support assembly is configured to be elevated with respect to the surface and a depressed, stationary load bearing position wherein the load support assembly is configured to rest on the surface, the load support assembly comprising:
a support assembly platform configured to receive the load; and
a plurality of support assembly legs extending from the support assembly platform; and
a plurality of platform biasing devices biasing the load support assembly in the elevated, transport position.

2. The elevated step assist apparatus of claim 1 wherein each of the plurality of platform biasing devices comprises at least one coiled platform suspension spring.

3. The elevated step assist apparatus of claim 1 further comprising a handle carried by the load support assembly.

4. The elevated step assist apparatus of claim 3 wherein the handle is carried by the plurality of support assembly legs of the load support assembly.

5. The elevated step assist apparatus of claim 4 further comprising at least one handle sleeve carried by the plurality of support assembly legs, and wherein the handle is removably insertable in the at least one handle sleeve.

6. The elevated step assist apparatus of claim 5 wherein the at least one handle sleeve comprises a pair of handle sleeves and the handle comprises a pair of elongated, parallel, spaced-apart vertical handle members and a horizontal handle member extending between the vertical handle members, the vertical handle members removably insertable in the pair of handle sleeves, respectively.

7. The elevated step assist apparatus of claim 1 further comprising at least one platform lock assembly configured to maintain the load support assembly in the elevated, transport position.

8. The elevated step assist apparatus of claim 7 wherein the at least one platform lock assembly comprises a plurality of platform lock assemblies.

9. The elevated step assist apparatus of claim 7 wherein the at least one platform lock assembly comprises an elongated lock member pivotally carried by the transport platform of the transport assembly, the lock member selectively deployable in an unlocking position disengaging the plurality of support assembly legs to facilitate deployment of the load support assembly between the transport position and the stationary load bearing position and a locking position engaging the plurality of support assembly legs to maintain the load support assembly in the transport position.

10. The elevated step assist apparatus of claim 9 further comprising a lock member engaging element on at least one of the plurality of support assembly legs, and wherein the lock member engaging element is configured to engage the lock member in the locking position of the lock member.

11. The elevated step assist apparatus of claim 10 wherein the lock member engaging element comprises a bolt on the at least one of the plurality of support assembly legs and a nut threaded on the bolt.

12. An elevated step assist apparatus configured to support a load on a surface, comprising:
a transport assembly comprising:
a plurality of transport wheels configured to rest on the surface; and
a transport platform carried by the plurality of transport wheels;
a load support assembly disposed over the transport assembly and deployable in an elevated, transport position wherein the load support assembly is configured to be elevated with respect to the surface and a depressed, stationary load bearing position wherein the load support assembly is configured to rest on the surface, the load support assembly comprising:
a support assembly platform configured to receive the load; and
a plurality of support assembly legs extending from the support assembly platform, each of the plurality of support assembly legs having:
a proximal leg end at the support assembly platform;
a distal leg end opposite the proximal leg end; and
a leg midpoint between the proximal leg end and the distal leg end; and
a plurality of platform biasing devices connecting the plurality of support assembly legs, respectively, of the load support assembly to the transport platform of the transport assembly, each of the plurality of platform biasing devices having a platform attachment end attached to the transport platform and a leg attachment end attached to a corresponding one of the plurality of support assembly legs substantially between the distal leg end and the leg midpoint, the plurality of platform biasing devices configured to contract and suspend the load support assembly from the transport assembly in the elevated, transport position of the load support assembly and the plurality of platform biasing devices configured to extend between the transport assembly and the load support assembly in the depressed, stationary load bearing position of the load support assembly.

13. The elevated step assist apparatus of claim 12 wherein each of the plurality of platform biasing devices comprises at least one coiled platform suspension spring.

14. The elevated step assist apparatus of claim 12 further comprising a handle carried by the load support assembly.

15. The elevated step assist apparatus of claim 14 wherein the handle is carried by the plurality of support assembly legs of the load support assembly.

16. The elevated step assist apparatus of claim 15 further comprising at least one handle sleeve carried by the plurality of support assembly legs, and wherein the handle is removably insertable in the at least one handle sleeve.

17. The elevated step assist apparatus of claim 16 wherein the at least one handle sleeve comprises a pair of handle sleeves and the handle comprises a pair of elongated, parallel, spaced-apart vertical handle members and a horizontal handle member extending between the vertical handle members, the vertical handle members removably insertable in the pair of handle sleeves, respectively.

18. The elevated step assist apparatus of claim 12 further comprising a plurality of platform lock assemblies configured to maintain the load support assembly in the elevated, transport position, each of the plurality of platform lock assemblies comprising an elongated lock member pivotally carried by the transport platform of the transport assembly, the lock member selectively deployable in an unlocking position disengaging a corresponding one of the plurality of support assembly legs to facilitate deployment of the load support assembly between the transport position and the stationary load bearing position and a locking position engaging the corresponding one of the plurality of support assembly legs to maintain the load support assembly in the transport position.

19. An elevated step assist apparatus configured to support a load on a surface, comprising:
a transport assembly comprising:
a plurality of transport wheels configured to rest on the surface; and
an elongated, rectangular transport platform carried by the plurality of transport wheels, the transport platform having a pair of elongated, parallel, spaced-apart longitudinal transport platform edges, a pair of elongated, parallel, spaced-apart transverse transport platform edges extending between the longitudinal transport platform edges and a plurality of transport platform corners between the longitudinal transport platform edges and the transverse transport platform edges;
a load support assembly disposed over the transport assembly and deployable in an elevated, transport position wherein the load support assembly is configured to be elevated with respect to the surface and a depressed, stationary load bearing position wherein the load support assembly is configured to rest on the surface, the load support assembly comprising:
a support assembly platform configured to receive the load, the support assembly platform disposed over and parallel to the transport platform of the transport assembly; and
a plurality of support assembly legs extending from the support assembly platform adjacent to the plurality of transport platform corners, respectively, on the transport platform of the transport assembly, each of the plurality of support assembly legs having:
a proximal leg end at the support assembly platform;
a distal leg end opposite the proximal leg end; and
a leg midpoint between the proximal leg end and the distal leg end;
a pair of handle sleeves on a pair, respectively, of the plurality of support assembly legs; and
a handle having a pair of elongated, parallel, spaced-apart vertical handle members and a horizontal handle member extending between the vertical handle members, the vertical handle members removably insertable in the pair of handle sleeves, respectively; and
a plurality of platform suspension springs connecting the plurality of support assembly legs, respectively, of the load support assembly to the transport platform of the transport assembly, each of the plurality of platform suspension springs having a platform attachment end attached to a corresponding one of the longitudinal transport platform edges of the transport platform and a leg attachment end attached to a corresponding one of the plurality of support assembly legs between the distal leg end and the leg midpoint, the plurality of platform suspension springs configured to contract and relax to suspend the load support assembly from the transport assembly in the elevated, transport position of the load support assembly and the plurality of platform suspension springs configured to extend and tension between the transport assembly and the load support assembly in the depressed, stationary load bearing position of the load support assembly.

20. The elevated step assist apparatus of claim 19 further comprising a plurality of platform lock assemblies configured to maintain the load support assembly in the elevated, transport position, each of the plurality of platform lock assemblies comprising an elongated lock member pivotally carried by the transport platform of the transport assembly, the lock member selectively deployable in an unlocking position disengaging a corresponding one of the plurality of support assembly legs to facilitate deployment of the load support assembly between the transport position and the stationary load bearing position and a locking position engaging the corresponding one of the plurality of support assembly legs to maintain the load support assembly in the transport position.
